(19) United States
(12) Patent Application Publication
(10) Pub. No.: US 2014/0319077 A1
(43) Pub. Date: Oct. 30, 2014

(54) EXCIPIENT REMOVAL FROM PHARMACOLOGICAL SAMPLES

(71) Applicant: FloDesign Sonics, Inc., Wilbraham, MA (US)

(72) Inventors: Bart Lipkens, Hampden, MA (US); Ari Mercado, Agawam, MA (US); Arthur Martin, Sutton, MA (US); Louis Masi, Longmeadow, MA (US); Jason Dionne, Simsbury, CT (US)

(73) Assignee: FloDesign Sonics, Inc., Wilbraham, MA (US)

(21) Appl. No.: 14/262,569

(22) Filed: Apr. 25, 2014

Related U.S. Application Data
(60) Provisional application No. 61/815,818, filed on Apr. 25, 2013.

(51) Int. Cl. B01D 21/00

(52) U.S. Cl. CPC B01D 21/00
USPC 210/748.05

(57) ABSTRACT

Active pharmaceutical ingredients can be separated from their excipients by dissolving a pharmaceutical product (e.g. tablet, pill) into a solvent, then running the solution through an acoustophoretic device. Standing waves are used to separate the excipient from the active ingredient dissolved in the solvent.

### CROSS-REFERENCE TO RELATED APPLICATIONS

This application claims priority to U.S. Provisional Patent Application Ser. No. 61/815,818, filed on Apr. 25, 2013. The contents of this application are hereby fully incorporated by reference herein.

### BACKGROUND

The present disclosure relates to acoustophoretic systems and processes for their use. More specifically, their use in capturing active pharmaceutical ingredients is described herein.

Both over-the-counter and prescription medications are made in several different forms, such as tablets, pills, capsules, pellets, creams, films, gels, etc. An important component of their manufacture is the analysis of such pharmacological products for the amount and character of the active pharmacological ingredient (API) contained therein.

Analyzing the pharmacological materials generally involves breaking down the API and its constituent carrying material, and filtering out the inactive material. For example, when the API is mixed into pill form, the inactive materials (or excipients) are broken apart and the API is solubilized in an appropriate solution. The mixture is then filtered (e.g. using a 0.25 micron filter) and then subsequently tested on a high-performance liquid chromatograph (HPLC) to determine the API both qualitatively and quantitatively. Various columns, detectors and mobile phases are used in this process. There are also other types of testing criteria that are used for separating the non-active ingredients from the API.

An example of the filtered HPLC type of testing is the testing that is performed on acetaminophen tablets. The acetaminophen tablet is broken down into small particle sizes using an appropriate method, such as a mortar and pestle, or ultrasonication. An appropriate solvent, such as alcohol or vodka, is used to dissolve the API out of the small particles. The solution is then filtered and run on an HPLC.

The filtration step is tedious and can create errors when some of the small particles remain in the solution that is to be run on the HPLC. These small particles can clog or destroy the column that is used on the HPLC, rendering the analysis of the API more difficult. There is also a cost involved in both the filters and the possible replacement of the HPLC columns. Also, filtering samples using membrane filters is tedious, costly and the filters themselves are prone to getting clogged, causing throughput issues. In some newer pharmaceutical formulations that use polymers in the tablets, finding a filter that works without clogging can be a challenge.

The removal of small particles from a crushed pharmaceutical product without the need to use physical filters while still eliminating very fine particles from the solution prior to analysis, is greatly desired.

### BRIEF DESCRIPTION

The present disclosure relates to the use of a standing wave or waves generated by an ultrasonic transducer or transducers to isolate an active ingredient from a pharmaceutical delivery system. More particular, the standing waves can separate fine particles from an analyte solution and permit the subsequent determination, qualitatively and quantitatively, of the active pharmaceutical ingredient (API). This separation of the active ingredient from the excipients is performed by taking advantage of the difference in the acoustic contrast factors of the excipients and the dissolved API in an appropriate fluid stream. The processes described herein can be used, for example, for quality control.

Disclosed in embodiments herein are processes for isolating an active ingredient from a pharmaceutical delivery system, comprising: dissolving the pharmaceutical delivery system in a solvent to form a fluid stream that contains the active ingredient dissolved in the solvent and suspended particles derived from the pharmaceutical delivery system; flowing the fluid stream through an apparatus that comprises: a flow chamber having at least one inlet and at least one outlet; at least one ultrasonic transducer located on a wall of the flow chamber, the transducer including a piezoelectric material; and a reflector located on the wall on the opposite side of the flow chamber from the at least one ultrasonic transducer; and generating a multi-dimensional standing wave in the flow chamber to capture the suspended particles in the fluid stream; and recovering the solvent and the active ingredient dissolved in the solvent.

Sometimes, the suspended particles are excipients from the pharmaceutical delivery system.

The frequency of the at least one ultrasonic transducer may be equal to or greater than 1 MHz.

In particular embodiments, the fluid stream flows sequentially past a first ultrasonic transducer, a second ultrasonic transducer, and a third ultrasonic transducer; wherein the second ultrasonic transducer operates at a higher frequency than the first ultrasonic transducer, and the third ultrasonic transducer operates at a higher frequency than the second ultrasonic transducer. In more specific embodiments, the second ultrasonic transducer operates at a frequency at least 1 MHz greater than the frequency of the first ultrasonic transducer, and the third ultrasonic transducer operates at a frequency at least 1 MHz greater than the frequency of the second ultrasonic transducer.

The process can further comprise applying an electric field to the fluid stream to further capture suspended particles in the fluid stream.

Sometimes, the apparatus comprises a communition chamber upstream of the flow chamber in which the pharmaceutical delivery system is broken up and dissolved in the solvent to form the fluid stream.

The multi-dimensional standing wave may be normal to the flow direction of the fluid stream.

The ultrasonic transducer may comprise: a housing having a top end, a bottom end, and an interior volume; and a crystal at the bottom end of the housing having an exposed exterior surface and an interior surface, the crystal being able to vibrate when driven by a voltage signal.

Sometimes, a backing layer contacts the interior surface of the crystal, the backing layer being made of a substantially acoustically transparent material. The substantially acoustically transparent material can be balsa wood, cork, or foam. The substantially acoustically transparent material may have a thickness of up to 1 inch. The substantially acoustically transparent material can be in the form of a lattice.

In some embodiments, an exterior surface of the crystal is covered by a wear surface material with a thickness of a half wavelength or less, the wear surface material being a urethane, epoxy, or silicone coating. In others, the crystal has no backing layer or wear layer.

The fluid stream can flow from an apparatus inlet through an annular plenum and past a contoured nozzle wall prior to entering the flow chamber inlet.

Alternatively, the fluid stream may flow from an apparatus inlet through an annular plenum and past a contoured nozzle wall to generate large scale vortices at the entrance to a collection duct prior to entering the flow chamber inlet, thus enhancing separation of the suspended particles from the active ingredient.

The reflector may have a non-planar surface.

The apparatus may further comprise: an apparatus inlet that leads to an annular plenum; a contoured nozzle wall downstream of the apparatus inlet; a collection duct surrounded by the annular plenum; and a connecting duct joining the contoured nozzle wall to the flow chamber inlet.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a side cross-sectional view of an exemplary acoustophoretic separator.

FIG. 2 is a side cross-sectional view of a second exemplary acoustophoretic separator.

FIG. 3 is a side cross-sectional view of a third exemplary acoustophoretic separator.

FIG. 4A is a detail view of a diffuser used as an inlet in the separator of FIG. 3.

FIG. 4B is a detail view of an alternate inlet diffuser that can be used with the separator of FIG. 3.

FIG. 5A shows another embodiment of an acoustophoretic separator.

FIG. 5B is a magnified view of fluid flow near the intersection of the contoured nozzle wall 129 and the collection duct 137 in the device of FIG. 5A.

FIG. 6A shows an exploded view of another acoustophoretic separator having one separation chamber.

FIG. 6B shows an exploded view of a stacked acoustophoretic separator with two acoustic chambers.

FIG. 7 is a cross-sectional diagram of a conventional ultrasonic transducer.

FIG. 8 is a picture of a wear plate of a conventional transducer.

FIG. 9A is a cross-sectional diagram of an ultrasonic transducer of the present disclosure. An air gap is present within the transducer, and no backing layer or wear plate is present.

FIG. 9B is a cross-sectional diagram of an ultrasonic transducer of the present disclosure. An air gap is present within the transducer, and a backing layer and wear plate are present.

FIG. 10 is a graph of electrical impedance amplitude versus frequency for a square transducer driven at different frequencies.

FIG. 11 illustrates the trapping line configurations for seven of the peak amplitudes of FIG. 10 from the direction orthogonal to fluid flow.

FIG. 12 is a graph showing Impedance vs. Frequency and Phase Angle vs. Frequency for an experimental setup.

FIG. 13 is a graph showing Real Power vs. Frequency and Phase Angle vs. Frequency for the experimental setup.

FIG. 14 is a picture of three flasks showing solutions before separation, after separation, and residual solution left in the acoustophoretic flow chamber.

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

The singular forms “a,” “an,” and “the” include plural referents unless the context clearly dictates otherwise.

Numerical values should be understood to include numerical values which are the same when reduced to the same number of significant figures and numerical values which differ from the stated value by less than the experimental error of the conventional measurement technique used to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified. More specifically, these terms refer to plus or minus 10% of the indicated number. The modifier “about” should also be considered as disclosing the range defined by the absolute values of the two endpoints. For example, the expression “from about 2 to about 4” also discloses the range “from 2 to 4.”

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that require the presence of the named component and permit the presence of other components. However, such description should be construed as also describing the devices and parts as “consisting of” and “consisting essentially of” the enumerated components, which allows the presence of only the named component, along with any impurities that might result from the manufacture of the named component, and excludes other components.

It should be noted that many of the terms used herein are relative terms. For example, the terms “upper” and “lower” are relative to each other in location, i.e. an upper component is located at a higher elevation than a lower component in a given orientation, but these terms can change if the device is flipped. The terms “inlet” and “outlet” are relative to a fluid flowing through them with respect to a given structure, e.g. a fluid flows through the inlet into the structure and flows through the outlet out of the structure. The terms “upstream” and “downstream” are relative to the direction in which a fluid flows through various components, i.e. the flow fluids through an upstream component prior to flowing through the downstream component. It should be noted that in a loop, a first component can be described as being both upstream of and downstream of a second component.

The terms “horizontal” and “vertical” are used to indicate direction relative to an absolute reference, i.e. ground level. However, these terms should not be construed to require structures to be absolutely parallel or absolutely perpendicular to each other. For example, a first vertical structure and a second vertical structure are not necessarily parallel to each other. The terms “top” and “bottom” or “base” are used to refer to surfaces where the top is always higher than the bottom/base relative to an absolute reference, i.e. the surface of the earth. The terms “above” and “below”, or “upwards” and “downwards” are also relative to an absolute reference; an upwards flow is always against the gravity of the earth.

The present disclosure refers to “the same order of magnitude.” Two numbers are of the same order of magnitude if the quotient of the larger number divided by the smaller number is a value less than 10.

The present disclosure relates to the use of an acoustophoretic device that can be used to separate suspended particles in an analyte solution in which an active pharmaceutical ingredient (API) is dissolved. The analyte solution is generally produced by dissolving a pharmaceutical delivery system in a solvent. The pharmaceutical delivery system includes an active pharmaceutical ingredient (API) and excipients. The term “excipient” refers to inactive ingredients that are included with the API to bulk up the formulation when producing a dosage form. General categories of excipients include, for example, antiadherents, binders, coatings, disintegrants, fillers, flavours, colours, lubricants, glidants, sorbents, preservatives, and sweeteners. The analyte solution thus contains the API dissolved in the solvent, and contains fine particles. The suspended particles are the excipients.

The suspended particles are then separated from the API. This is done via the difference in the acoustic contrast factors of the excipients (particles) and the dissolved API in the solvent. In this regard, the acoustic contrast factor of particles in a fluid medium is determined by Equation 1:

$$∅ = \frac{5 {ρ}_{p} - 2 {ρ}_{f}}{2 {ρ}_{ρ} + {ρ}_{f}} \frac{{β}_{ρ}}{{β}_{f}} \qquad Equation 1$$

wherein Ø is the acoustic contrast factor, ρ_{f} is the density of the fluid medium, ρₚ is the density of the particles in the fluid medium, β_{f} is the compressibility of the fluid medium, and βₚ is the compressibility of the particles in the fluid medium. The fluid medium here refers to the solvent. Because the active pharmaceutical ingredient (API) has different density and compressibility compared to the excipients, the API has a different acoustic contrast factor.

In the processes of the present disclosure, a multi-dimensional standing acoustic wave is formed through the use of an ultrasonic transducer and a reflector. The ultrasonic energy is tuned to resonance to generate the standing wave with nodes and anti-nodes.

A pressure profile is generated along the standing wave that has areas of minimum displacement (called nodes or nodal positions) and areas of maximum displacement (called antinodes). Referring to Equation 1, when a solution contains particles that are more “compressible” than the fluid medium, the particles will be subjected to a force that pushes them towards the nearest acoustic pressure maximum. On the other hand, if the particles are less compressible than the fluid, they will migrate towards the nearest acoustic pressure minimum. This constitutes the acoustic radiation force (ARF) that allows for trapping of the particles from the fluid stream.

In this regard, the acoustic radiation force (ARF) can be controlled by varying the frequency of the ultrasonic transducer. The ARF is calculated according to Equation 2:

$${F}_{p} = 4 π {R}^{3} {kE}_{ac} \cdot ∅ ( β , ρ ) \cdot sin ( \frac{4 π z}{λ} ) \qquad Equation 2$$

wherein E_{ac} is the energy density of the acoustic field, z is the distance from a pressure node, R is the radius of the excipient particle, k is the wave number of the driving frequency in the host fluid, and A is the wavelength of the driving frequency.

Three other forces will act on the suspended particles in the analyte solution: the drag force the fluid exerts on the particles, the buoyancy force, and gravity. The drag force is related to the viscosity and velocity of the fluid, and determines the speed at which particles can move through the fluid. The buoyancy force plays a small role if the particles and fluid have similar densities, but becomes significant as the differences in the densities increases. The density and elastic properties of the solvent can be modified to enhance the separation process.

Thus, the analyte solution containing suspended particles and dissolved active ingredient are exposed to a multi-dimensional standing wave. Generally, the excipients (i.e. suspended particles) in the fluid stream are gathered at the pressure nodes of the standing wave, allowing them to be separated from the fluid stream that contains the dissolved API from the pharmaceutical that is being tested. If their density is higher than the fluid stream, they will drop out of the fluid stream due to gravity and can be collected. If the excipient material is lighter in density than the fluid stream, then the materials will become buoyant and can be collected as they float to the top of the flow chamber.

The ultrasonic transducer is operated at a frequency of equal to or greater than 1 megahertz (MHz). In some embodiments, it is contemplated that multiple ultrasonic transducers are used at successively higher frequencies. Generally, the higher the frequency used, the smaller the size of the particles that can be captured. In particular embodiments, a successive downstream transducer is operated at a higher frequency than the adjacent upstream transducer. More particularly, the transducers differ in frequency by at least 1 MHz, and in particular embodiments by about 2 MHz. In particular embodiments, the use of three ultrasonic transducers is contemplated.

The use of electrophoresis, in conjunction with the acoustophoresis separation, is also contemplated in the present disclosure. In this regard, Equation 3 shows the electrophoretic mobility μₑ

$${μ}_{e} = \frac{{ɛ}_{r} {ɛ}_{0} ζ}{η} \qquad Equation 3$$

wherein εᵣ is the dielectric constant of the dispersion medium, ε₀ is the permittivity of free space (∥8.85×10⁻¹² C²/N·m²), η is the dynamic viscosity of the dispersion medium (Pa s), and ζ is the zeta potential.

Certain small particles, depending on their composition and zeta potential, will have excellent mobility or flocculation in a fluid when an electric field is applied. It is contemplated that the electric field is applied to the fluid stream after acoustophoresis. This is typically applied to capture particles having a diameter of one micron or less, which can be difficult for acoustophoresis to fully capture.

To practice the processes of the present disclosure, an analyte solution is first prepared by dissolving a pharmaceutical delivery system in a solvent to form the analyte solution. As explained above, the analyte solution contains the active ingredient dissolved in the solvent and suspended particles derived from the pharmaceutical delivery system. Generally, the suspended particles are the excipients. The solvent used in the analyte solution and used as a host fluid should be one in which the active ingredient is soluble. Such solvents can include water and alcohols, such as methanol or ethanol. The solvent can be considered a “host fluid” or a “carrier” for the excipients and the active ingredient.

Next, the analyte solution is used as a fluid stream that is flowed through an acoustophoretic apparatus. Several different apparatuses will be discussed further herein. The apparatus contains a flow chamber in which a multi-dimensional standing wave is generated. The standing wave is normal to the flow direction of the fluid stream. The standing wave captures the suspended particles in the fluid stream. The solvent and the active ingredient dissolved in the solvent then flow out of the flow chamber and can be captured. The active ingredient can then be recovered from the solvent using known methods, for example evaporation of the solvent, filtration, crystallization, etc. The processes described herein are usually practiced in batch form.

The acoustophoretic systems of the present disclosure can operate at the macro-scale for separations in flowing systems with high flow rates. The acoustic resonator is designed to create a high intensity three dimensional ultrasonic standing wave that results in an acoustic radiation force that is larger than the combined effects of fluid drag and buoyancy or gravity, and is therefore able to trap (i.e., hold stationary) the suspended phase to allow more time for the acoustic wave to increase particle concentration, agglomeration and/or coalescence. The present systems have the ability to create ultrasonic standing wave fields that can trap particles in flow fields with a linear velocity ranging from 0.1 mm/sec to velocities exceeding 1 cm/s. Excellent particle separation efficiencies have been demonstrated for particle sizes as small as one micron.

Again, the acoustophoretic separation technology employs ultrasonic standing waves to trap, i.e., hold stationary, secondary phase particles in a host fluid stream. This is an important distinction from previous approaches where particle trajectories were merely altered by the effect of the acoustic radiation force. The scattering of the acoustic field off the particles results in a three dimensional acoustic radiation force, which acts as a three-dimensional trapping field. The acoustic radiation force is proportional to the particle volume (e.g. the cube of the radius) when the particle is small relative to the wavelength. It is proportional to frequency and the acoustic contrast factor. It also scales with acoustic energy (e.g. the square of the acoustic pressure amplitude). For harmonic excitation, the sinusoidal spatial variation of the force is what drives the particles to the stable positions within the standing waves. When the acoustic radiation force exerted on the particles is stronger than the combined effect of fluid drag force and buoyancy/gravitational force, the particle is trapped within the acoustic standing wave field. The action of the acoustic forces on the trapped particles results in concentration, agglomeration and/or coalescence of particles and droplets. Additionally, secondary inter-particle forces, such as Bjerkness forces, aid in particle agglomeration. Heavier-than-the-host-fluid (i.e. denser than the host fluid) particles are separated through enhanced gravitational settling, and lighter-than-the-host-fluid particles are separated through enhanced buoyancy.

It is also possible to drive multiple ultrasonic transducers with arbitrary phasing. In other words, the multiple transducers may work to separate materials in a fluid stream while being out of phase with each other. Alternatively, a single ultrasonic transducer that has been divided into an ordered array may also be operated such that some components of the array will be out of phase with other components of the array.

Advanced multi-physics and multiple length scale computer models and high frequency (MHz), high-power, and high-efficiency ultrasonic drivers with embedded controls have been combined to arrive at new designs of acoustic resonators driven by arrays of piezoelectric transducers, resulting in acoustophoretic separation devices that far surpass current capabilities.

Desirably, such transducers generate a three-dimensional standing wave in the fluid that exerts a lateral force on the suspended particles to accompany the axial force so as to increase the particle trapping capabilities of a acoustophoretic system. Typical results published in literature state that the lateral force is two orders of magnitude smaller than the axial force. In contrast, the technology disclosed in this application provides for a lateral force to be of the same order of magnitude as the axial force. The system can be driven by a function generator and amplifier (not shown). The system performance is monitored and controlled by a computer.

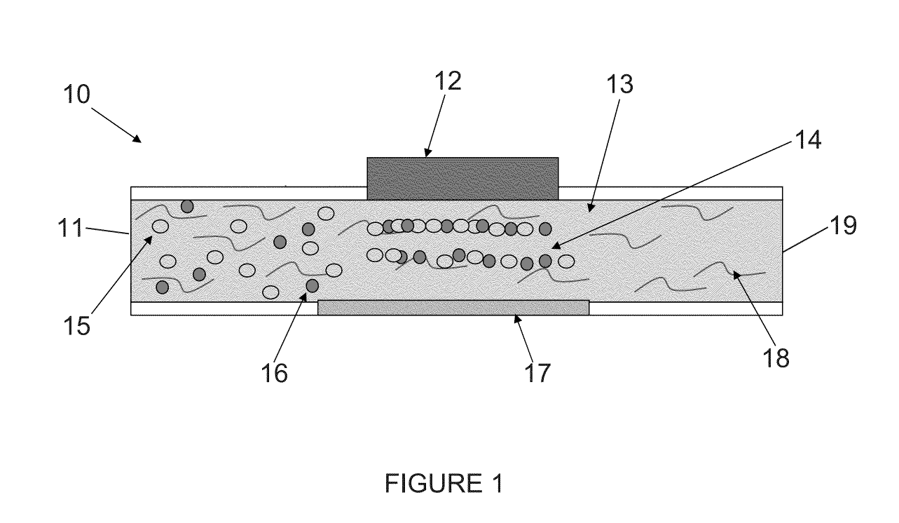

FIG. 1 is a side cross-sectional view of an exemplary acoustophoretic separator. The separator includes a flow chamber 10 that has an inlet 11 and an outlet 19. The analyte solution/fluid stream flowing in from the inlet is illustrated as being made up of solvent 13, suspended particles 15 and 16, and active ingredient 18. An ultrasonic transducer 12 containing a piezoelectric crystal is located opposite a reflector 17. A standing wave is generated between the transducer 12 and the reflector 17. The suspended particles are trapped in the standing wave; this is illustrated by the ordering of the particles at reference numeral 14. The active ingredient 18 is thus separated from the particles. The active ingredient and the solvent then flow out of outlet 19. The suspended particles can be trapped and discharged via a separate outlet (not shown).

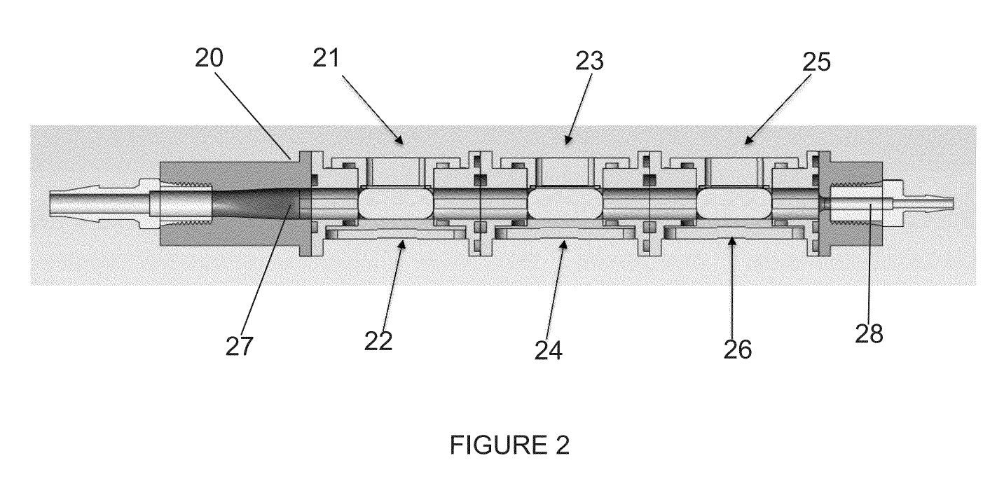

FIG. 2 is a side cross-sectional view of another exemplary acoustophoretic separator. In this particular embodiment, the flow chamber 20 includes an inlet 27 and an outlet 28. Within the flow chamber are three ultrasonic transducers 21, 23, 25. Opposite each transducer is a corresponding reflector 22, 24, 26. Here, successive downstream transducers are operated at successively higher frequencies. For example, transducer 21 may be operated at 4 MHz, transducer 23 may be operated at 6 MHz, and transducer 25 may be operated at 8 MHz. As discussed above, the frequencies usually differ by at least 1 MHz, and in particular embodiments by about 2 MHz. The frequencies of the transducer are generally between 1 MHz and 20 MHz. if desired, the flow chamber 20 illustrated here can be considered as being made up of three smaller chambers arranged in series. As illustrated here, the separator can be modularly constructed.

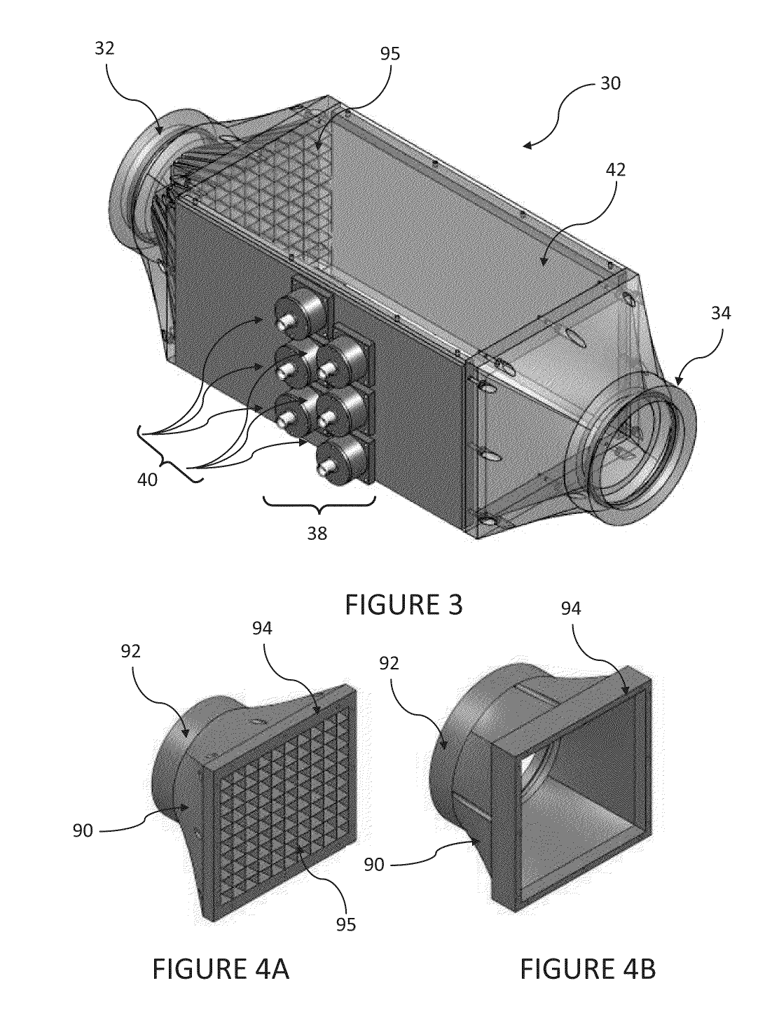

FIG. 3 shows yet another embodiment of an acoustophoretic particle separator 30. The acoustophoretic separator 30 has an inlet 32 and an outlet 34. The inlet 32 is fitted with a nozzle or diffuser 90 having a honeycomb 95 to facilitate the development of plug flow. The acoustophoretic separator 30 has an array 38 of transducers 40, in this case six transducers all arranged on the same wall. The transducers are arranged so that they cover the entire cross-section of the flow path. The acoustophoretic separation system of FIG. 3 has, in certain embodiments, a square cross section of 6 inches×6 inches which operates at flow rates of up to 3 gallons per minute (GPM), or a linear velocity of 8 mm/sec. The transducers 40 are six PZT-8 (Lead Zirconate Titanate) transducers with a 1 inch diameter and a nominal 2 MHz resonance frequency. Each transducer consumes about 28 W of power for droplet trapping at a flow rate of 3 GPM. This translates in an energy cost of 0.25 kW hr/m³. This is an indication of the very low cost of energy of this technology. Desirably, each transducer is powered and controlled by its own amplifier. Again, this embodiment permits the capture and agglomeration, aggregation, clumping or coalescing of the suspended particles into much larger aggregates that can be easier to handle.

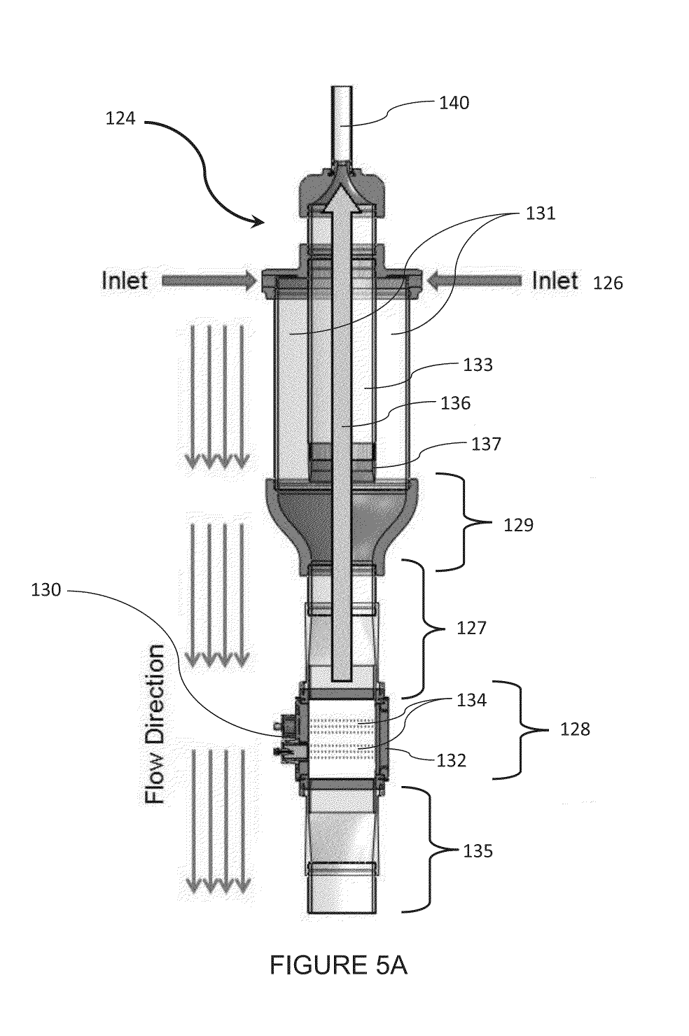

FIG. 4A and FIG. 4B show two different diffusers that can be used at the inlet of the acoustophoretic separator. The diffuser 90 has an entrance 92 (here with a circular shape) and an exit 94 (here with a square shape). The diffuser of FIG. 4A is illustrated in FIG. 3. FIG. 4A includes a grid or honeycomb 95, whereas FIG. 4B does not. The grid helps ensure uniform flow.

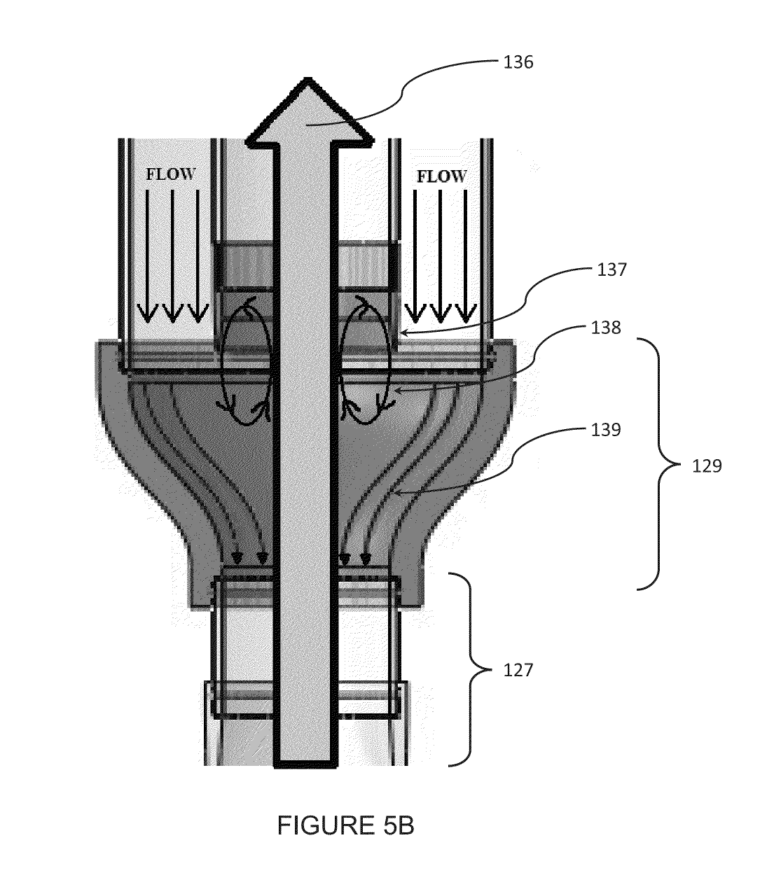

FIG. 5A shows a 4″ by 2.5″ flow cross sectional area intermediate scale apparatus 124 for separating particles from a solution. The acoustic path length is 4″. The apparatus is shown here in an orientation where the flow direction is downwards, which is used for separating less-dense particles from the fluid stream. However, the apparatus may be essentially turned upside down to allow separation of particles which are heavier than the solvent in the fluid stream. Instead of a buoyant force in an upward direction, the weight of the agglomerated particles due to gravity pulls them downward. It should be noted that this embodiment is depicted as having an orientation in which fluid flows vertically. However, it is also contemplated that fluid flow may be in a horizontal direction, or at an angle.

The analyte solution (containing dissolved active ingredient and suspended particles) enters the apparatus through inlets 126 into an annular plenum 131. The annular plenum has an annular inner diameter and an annular outer diameter. Two inlets are visible in this illustration, though it is contemplated that any number of inlets may be provided as desired. In particular embodiments, four inlets are used. The inlets are radially opposed and oriented.

A contoured nozzle wall 129 reduces the outer diameter of the flow path in a manner that generates higher velocities near the wall region and reduces turbulence, producing near plug flow as the fluid velocity profile develops, i.e. the fluid is accelerated downward in the direction of the centerline with little to no circumferential motion component and low flow turbulence. This generates a chamber flow profile that is optimum for acoustic separation and particle collection. The fluid passes through connecting duct 127 and into a flow/separation chamber 128. As seen in the zoomed-in contoured nozzle 129 in FIG. 5B, the nozzle wall also adds a radial motion component to the suspended particles, moving the particles closer to the centerline of the apparatus and generating more collisions with rising, buoyant agglomerated particles. This radial motion will allow for optimum scrubbing of the particles from the fluid in the connecting duct 127 prior to reaching the separation chamber. The contoured nozzle wall 129 directs the fluid in a manner that generates large scale vortices at the entrance of the collection duct 133 to also enhance particle collection. Generally, the flow area of the device 124 is designed to be continually decreasing from the annular plenum 131 to the separation chamber 128 to assure low turbulence and eddy formation for better particle separation, agglomeration, and collection. The nozzle wall has a wide end and a narrow end. The term scrubbing is used to describe the process of particle agglomeration, aggregation, clumping or coalescing, that occurs when a larger particle travels in a direction opposite to the fluid flow and collides with smaller particles, in effect scrubbing the smaller particles out of the suspension.

Returning to FIG. 5A, the flow/separation chamber 128 includes a transducer array 130 and reflector 132 on opposite sides of the chamber. In use, standing waves 134 are created between the transducer array 130 and reflector 132. These standing waves can be used to agglomerate particles, and this orientation is used to agglomerate particles that are buoyant. The solvent, containing the dissolved active ingredient, then exits through flow outlet 135.

As the buoyant particles agglomerate, they eventually overcome the combined effect of the fluid flow drag forces and acoustic radiation force, and their buoyant force 136 is sufficient to cause the buoyant particles to rise upwards. In this regard, a collection duct 133 is surrounded by the annular plenum 131. The larger particles will pass through this duct and into a collection chamber 140. This collection chamber can also be part of an outlet duct. The collection duct and the flow outlet are on opposite ends of the apparatus.

It should be noted that the buoyant particles formed in the separation chamber 128 subsequently pass through the connecting duct 127 and the nozzle wall 129. This causes the incoming flow from the annular plenum to flow over the rising agglomerated particles due to the inward radial motion imparted by the nozzle wall. This allows the rising particles to also trap smaller particles in the incoming flow, increasing scrubbing effectiveness. The length of the connecting duct 127 and the contoured nozzle wall 129 thus increase scrubbing effectiveness. Especially high effectiveness is found for particles with a size of 0.1 microns to 20 microns, where efficiency is very low for conventional methods.

The design here provides an optimized velocity profile with low flow turbulence at the inlet to the flow chamber 128, a scrubbing length before the flow chamber to enhance particle agglomeration and/or coalescence before acoustic separation, and the use of the collection vortices to aid particle removal at the collection duct 133.

Generally speaking but with specific reference to the transducer array of FIG. 5A, the transducer setup of the present disclosure creates a three dimensional pressure field which includes standing waves perpendicular to the fluid flow. The pressure gradients are large enough to generate acoustophoretic forces orthogonal to the standing wave direction (i.e., the acoustophoretic forces are parallel to the fluid flow direction) which are of the same order of magnitude as the acoustophoretic forces in the wave direction. This permits enhanced particle trapping and collection in the flow chamber and along well-defined trapping lines, as opposed to merely trapping particles in collection planes as in conventional devices. The particles have significant time to move to nodes or anti-nodes of the standing waves, generating regions where the particles can concentrate, agglomerate, and/or coalesce.

In some embodiments, the fluid stream has a Reynolds number of up to 1500, i.e. laminar flow is occurring. For practical application in industry, the Reynolds number is usually from 10 to 1500 for the flow through the system. The Reynolds number represents the ratio of inertial flow effects to viscous effects in a given flow field. For Reynolds numbers below 1.0, viscous forces are dominant in the flow field. This results in significant damping where shear forces are predominant throughout the flow. This flow where viscous forces are dominant is called Stokes flow. The flow of molasses is an example. Wall contouring and streamlining have very little importance during Stokes flow.

In the present systems, the Reynolds number for the flow through the system will be much greater than 1.0 because the fluid velocity and inlet diameter are much larger. For Reynolds numbers much greater than 1.0, viscous forces are dominant only where the flow is in contact with the surface. This viscous region near the surface is called a boundary layer and was first recognized by Ludwig Prandtl (Reference 2). In duct flow, the flow will be laminar if the Reynolds number is significantly above 1.0 and below 2300 for fully developed flow in the duct.

The transducer(s) is/are used to create a pressure field that generates forces of the same order of magnitude both orthogonal to the standing wave direction and in the standing wave direction. When the forces are roughly the same order of magnitude, particles of size 0.1 microns to 300 microns will be moved more effectively towards regions of agglomeration (“trapping lines”). Because of the equally large gradients in the orthogonal acoustophoretic force component, there are “hot spots” or particle collection regions that are not located in the regular locations in the standing wave direction between the transducer 130 and the reflector 132. Hot spots are located in the maxima or minima of acoustic radiation potential. Such hot spots represent particle collection locations which allow for better wave transmission between the transducer and the reflector during collection and stronger inter-particle forces, leading to faster and better particle agglomeration.

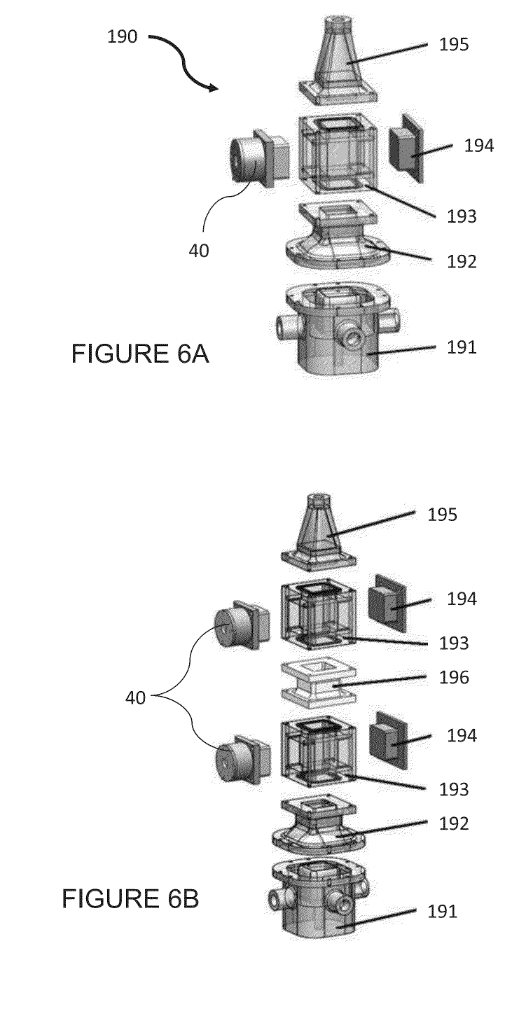

FIG. 6A and FIG. 6B are exploded views showing the various parts of additional acoustophoretic separators. FIG. 6A has only one flow/separation chamber, while FIG. 6B has two flow/separation chambers.

Referring to FIG. 6A, the fluid stream enters the separator 190 through a four-port inlet 191. A transition piece 192 is provided to create plug flow through the separation chamber 193. A transducer 40 and a reflector 194 are located on opposite walls of the separation chamber. The solvent containing active ingredient and reduced quantity of suspended particles then exits the separation chamber 193 and the separator through outlet 195.

FIG. 6B has two separation chambers 193. A system coupler 196 is placed between the two chambers 193 to join them together.

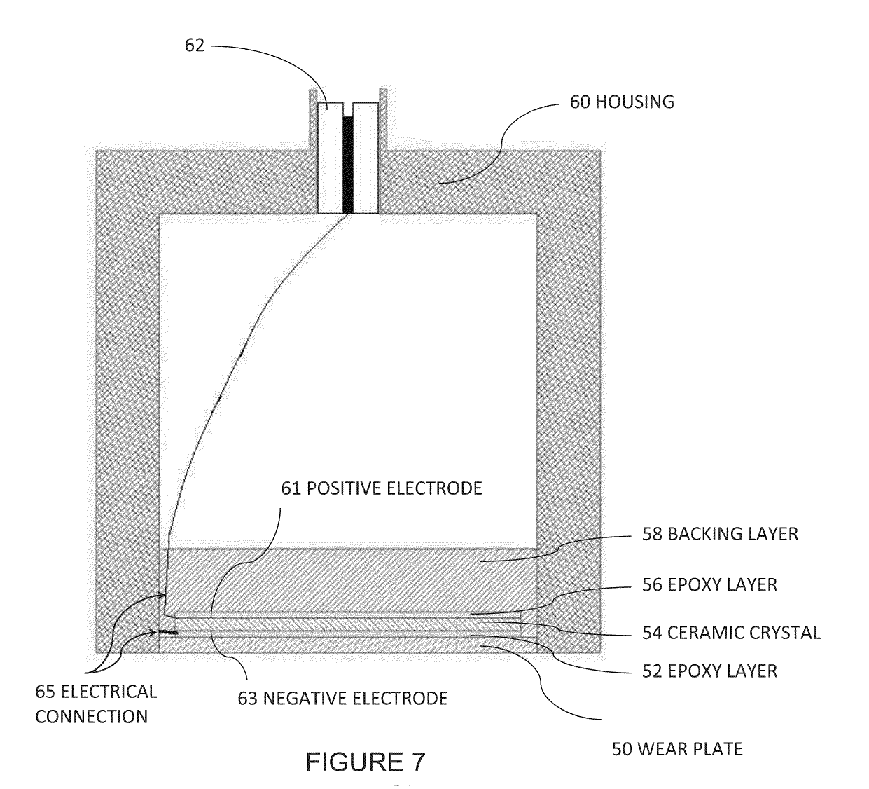

The systems of the present disclosure use a unique ultrasonic transducer. FIG. 7 is a cross-sectional diagram of a conventional ultrasonic transducer. This transducer has a wear plate 50 at a bottom end, epoxy layer 52, ceramic crystal 54 (made of, e.g. PZT), an epoxy layer 56, and a backing layer 58. On either side of the ceramic crystal, there is an electrode: a positive electrode 61 and a negative electrode 63. The epoxy layer 56 attaches backing layer 58 to the crystal 54. The entire assembly is contained in a housing 60 which may be made out of, for example, aluminum. An electrical adapter 62 provides connection for wires to pass through the housing and connect to leads (not shown) which attach to the crystal 54. Typically, backing layers are designed to add damping and to create a broadband transducer with uniform displacement across a wide range of frequency and are designed to suppress excitation at particular vibrational eigen-modes. Wear plates are usually designed as impedance transformers to better match the characteristic impedance of the medium into which the transducer radiates.

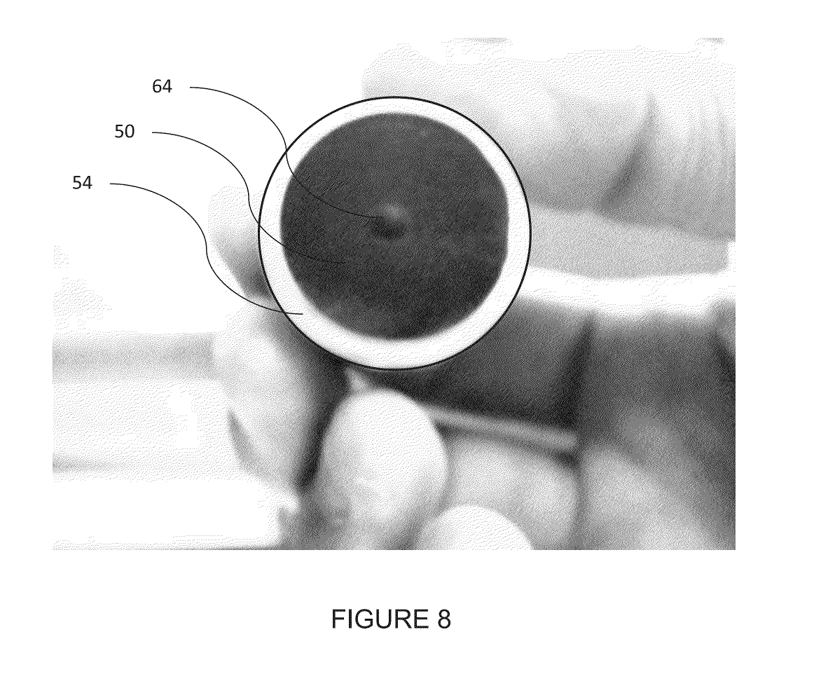

FIG. 8 is a photo of a wear plate 50 with a bubble 64 where the wear plate has pulled away from the ceramic crystal surface due to the oscillating pressure and heating.

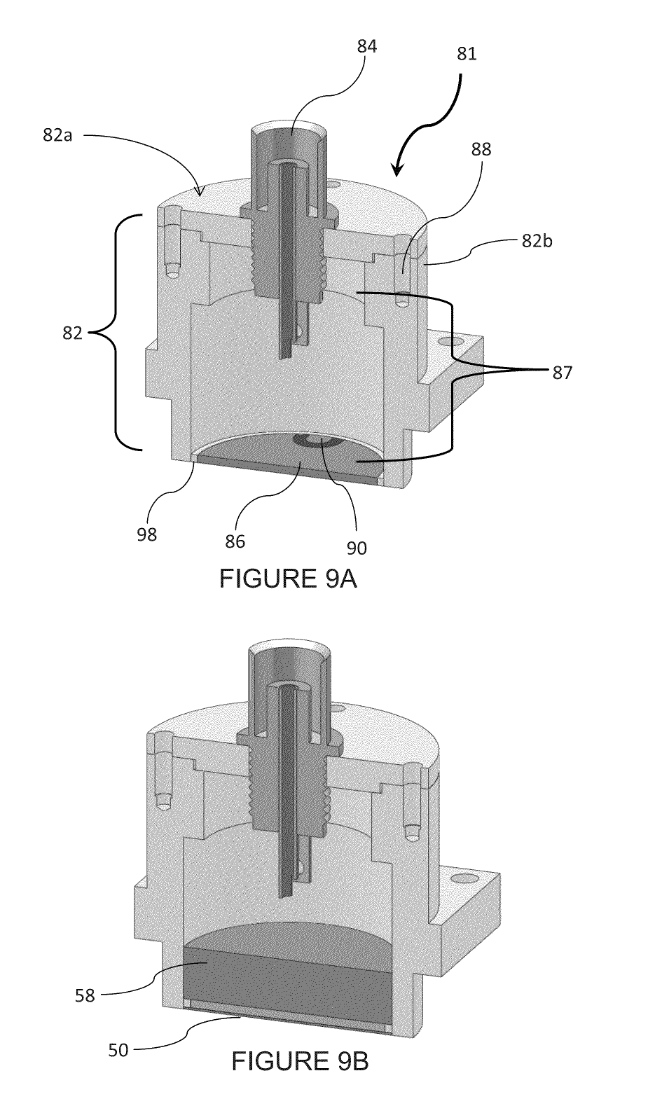

FIG. 9A is a cross-sectional view of an ultrasonic transducer 81 of the present disclosure, which can be used with the acoustophoretic systems and apparatuses of the present disclosure. Transducer 81 has an aluminum housing 82. A PZT crystal 86 defines the bottom end of the transducer, and is exposed from the exterior of the housing. The crystal is supported on its perimeter by a small elastic layer 98, e.g. silicone or similar material, located between the crystal and the housing. Put another way, no wear layer is present.

Screws (not shown) attach an aluminum top plate 82a of the housing to the body 82b of the housing via threads 88. The top plate includes a connector 84 to pass power to the PZT crystal 86. The bottom and top surfaces of the PZT crystal 86 are each connected to an electrode (positive and negative), such as silver or nickel. A wrap-around electrode tab 90 connects to the bottom electrode and is isolated from the top electrode. Electrical power is provided to the PZT crystal 86 through the electrodes on the crystal, with the wrap-around tab 90 being the ground connection point. Note that the crystal 86 has no backing layer or epoxy layer as is present in FIG. 7. Put another way, there is an air gap 87 in the transducer between aluminum top plate 82a and the crystal 86 (i.e. the air gap is completely empty). A minimal backing 58 and/or wear plate 50 may be provided in some embodiments, as seen in FIG. 9B.

The transducer design can affect performance of the system. A typical transducer is a layered structure with the ceramic crystal bonded to a backing layer and a wear plate. Because the transducer is loaded with the high mechanical impedance presented by the standing wave, the traditional design guidelines for wear plates, e.g., half wavelength thickness for standing wave applications or quarter wavelength thickness for radiation applications, and manufacturing methods may not be appropriate. Rather, in one embodiment of the present disclosure the transducers, there is no wear plate or backing, allowing the crystal to vibrate in one of its eigenmodes with a high Q-factor. The vibrating ceramic crystal/disk is directly exposed to the fluid flowing through the flow chamber.

Removing the backing (e.g. making the crystal air backed) also permits the ceramic crystal to vibrate at higher order modes of vibration with little damping (e.g. higher order modal displacement). In a transducer having a crystal with a backing, the crystal vibrates with a more uniform displacement, like a piston. Removing the backing allows the crystal to vibrate in a non-uniform displacement mode. The higher order the mode shape of the crystal, the more nodal lines the crystal has. The higher order modal displacement of the crystal creates more trapping lines, although the correlation of trapping line to node is not necessarily one to one, and driving the crystal at a higher frequency will not necessarily produce more trapping lines.

In some embodiments, the crystal may have a backing that minimally affects the Q-factor of the crystal (e.g. less than 5%). The backing may be made of a substantially acoustically transparent material such as balsa wood, foam, or cork which allows the crystal to vibrate in a higher order mode shape and maintains a high Q-factor while still providing some mechanical support for the crystal. The backing layer may be a solid, or may be a lattice having holes through the layer, such that the lattice follows the nodes of the vibrating crystal in a particular higher order vibration mode, providing support at node locations while allowing the rest of the crystal to vibrate freely. The goal of the lattice work or acoustically transparent material is to provide support without lowering the Q-factor of the crystal or interfering with the excitation of a particular mode shape.

Placing the crystal in direct contact with the fluid stream also contributes to the high Q-factor by avoiding the dampening and energy absorption effects of the epoxy layer and the wear plate. Other embodiments may have wear plates or a wear surface to prevent the PZT, which contains lead, from contacting the host fluid. Such applications might use a wear layer such as chrome, electrolytic nickel, or electroless nickel. Chemical vapor deposition could also be used to apply a layer of poly(p-xylylene) (e.g. Parylene) or other polymer. Organic and biocompatible coatings such as silicone or polyurethane are also usable as a wear surface.

In the present disclosure, the system is operated at a voltage such that the particles are trapped in the ultrasonic standing wave, i.e., remain in a stationary position. The particles are collected in along well defined trapping lines, separated by half a wavelength. Within each nodal plane, the particles are trapped in the minima of the acoustic radiation potential. The axial component of the acoustic radiation force drives the particles, with a positive contrast factor, to the pressure nodal planes, whereas particles with a negative contrast factor are driven to the pressure anti-nodal planes. The radial or lateral component of the acoustic radiation force is the force that traps the particle. In systems using typical transducers, the radial or lateral component of the acoustic radiation force is typically several orders of magnitude smaller than the axial component of the acoustic radiation force. However, the lateral force in the separators of the present disclosure can be significant, on the same order of magnitude as the axial force component, and is sufficient to overcome the fluid drag force at linear velocities of up to 1 cm/s. As discussed above, the lateral force can be increased by driving the transducer in higher order mode shapes, as opposed to a form of vibration where the crystal effectively moves as a piston having a uniform displacement. The acoustic pressure is proportional to the driving voltage of the transducer. The electrical power is proportional to the square of the voltage.

In embodiments, the pulsed voltage signal driving the transducer can have a sinusoidal, square, sawtooth, or triangle waveform; and have a frequency of 500 kHz to 10 MHz. The pulsed voltage signal can be driven with pulse width modulation, which produces any desired waveform. The pulsed voltage signal can also have amplitude or frequency modulation start/stop capability to eliminate streaming.

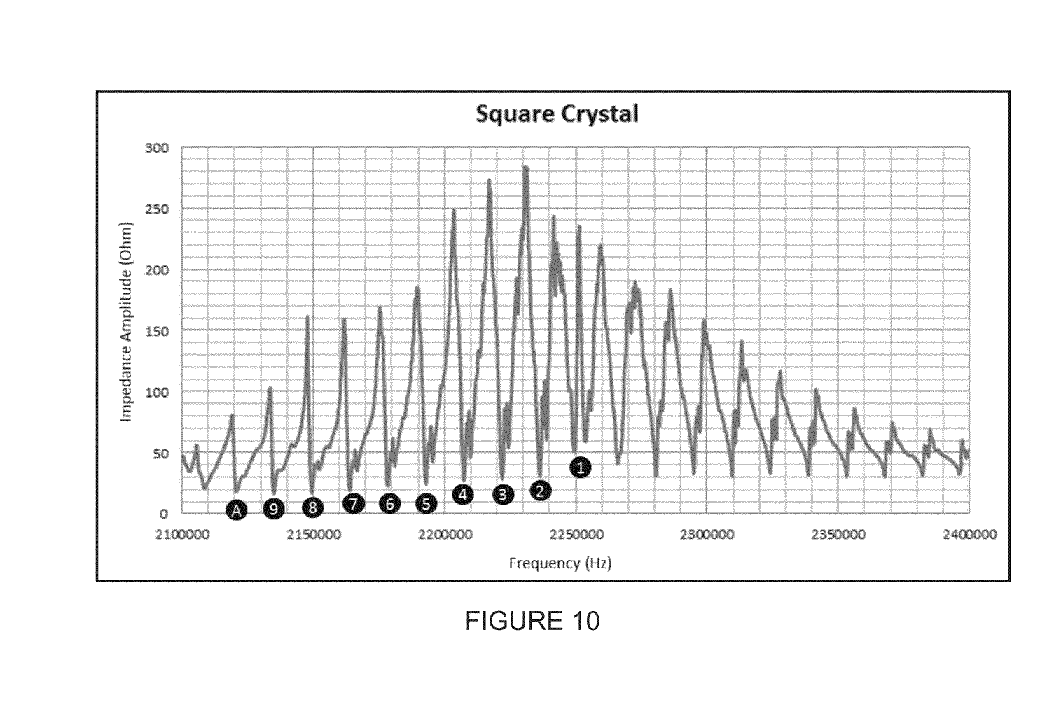

FIG. 10 shows the measured electrical impedance amplitude of a square transducer as a function of frequency in the vicinity of the 2.2 MHz transducer resonance. The minima in the transducer electrical impedance correspond to acoustic resonances of the water column and represent potential frequencies for operation. Numerical modeling has indicated that the transducer displacement profile varies significantly at these acoustic resonance frequencies indicated by circled numbers 1-9 and letter A, and thereby directly affects the acoustic standing wave and resulting trapping force. Since the transducer operates near its thickness resonance, the displacements of the electrode surfaces are essentially out of phase. The typical displacement of the transducer electrodes is not uniform and varies depending on frequency of excitation. As an example, at one frequency of excitation with a single line of trapped oil droplets, the displacement has a single maximum in the middle of the electrode and minima near the transducer edges. At another excitation frequency, the transducer profile has multiple maxima leading to multiple trapped lines of oil droplets. Higher order transducer displacement patterns result in higher trapping forces and multiple stable trapping lines for the captured oil droplets.

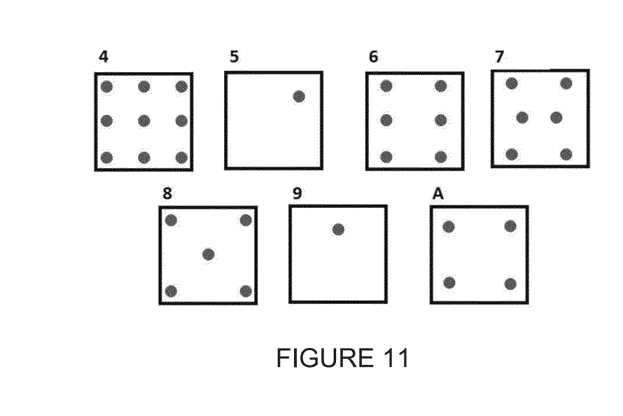

FIG. 11 illustrates the pattern of the number of trapping lines across the fluid channel generated with seven of the ten resonance frequencies identified in FIG. 10. Different displacement profiles of the transducer can produce different (more) trapping lines in the standing waves, with more gradients in displacement profile generally creating higher trapping forces and more trapping lines to capture suspended particles.

The following examples are for purposes of further illustrating the present disclosure. The examples are merely illustrative and are not intended to limit the disclosure to the devices, materials, conditions, or process parameters set forth therein.

### EXAMPLES

In an experimental setup, TYLENOL pills containing acetaminophen were dissolved in ethanol, and the excipients were then separated using an acoustophoretic apparatus. The following materials, hardware, and procedure were used in the test.

The following hardware was used: (a) an acoustophoretic system containing a flow chamber with a single ultrasonic transducer; (b) an oscilloscope, function generator and amplifier; (c) a Bausch and Lomb Spectrophotometer SPEC-20D; (d) a PC desktop with the LabView program running; (e) a digital weight scale; and (f) a pump and hoses.

The TYLENOL pills used contained 650 milligrams of acetaminophen. The ethanol used was 50% (v/v).

The TYLENOL/ethanol solution was flowed through the acoustophoretic system at a flow rate of 10 ml/min. The transducer was operated at a frequency of 1.981417 MHz, and a voltage of 8 Vpp. The test time was five (5) minutes.

Procedure:

1. One TYLENOL pill was dissolved in 400 ml of ethanol using an ultrasonic bath. Prior to dissolution, the pill was weighed as having a total weight of 774.8 milligrams. The solution thus contained 1.625% (w/v) acetaminophen.

2. The test system was set up.

3. An Impedance sweep study was performed in order to characterize the transducer response to the solution. Data curves of Impedance vs. Frequency, Phase Angle vs. Frequency, and Power vs. Frequency were obtained.

4. The time span of the test was set to 5 minutes.

5. A control test was run for 5 minutes without acoustics to verify that no precipitates were formed by the effect of the system's geometry.

6. Samples were taken before the beginning of the test from the reservoir and from the flow outlet of the system (control samples), in the outlet 2 minutes after the test started, and then at 5 minutes. After the test ended, the residual solution in the chamber was collected.

7. Samples of the solution before and after filtration, and the chamber residue were analyzed with the spectrophotometer and the vacuum filtration.

Results:

Impedance Sweep Study:

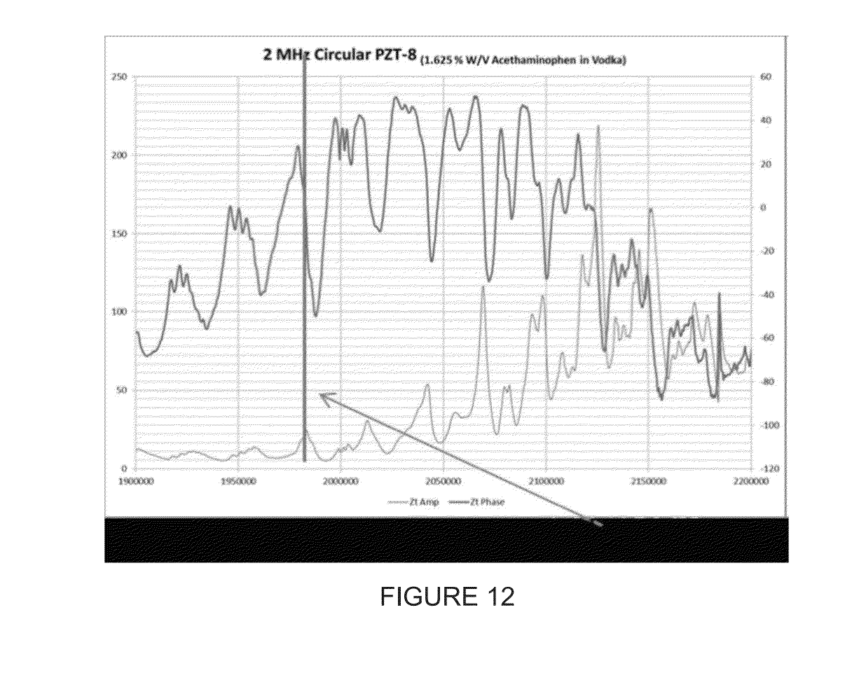

The impedance sweep performed to characterize the transducer response in the media (acetaminophen+ethanol), determined the range of possible working frequencies to be used during test. FIG. 12 contains the curves of Impedance vs. Frequency and Phase Angle vs. Frequency. The impedance is the light blue line, and the phase angle is the dark red line. The x-axis is the frequency, in Hz. The y-axis on the right-hand side is for the phase angle, which has units of degrees. The y-axis on the left-hand side is for the impedance, which has units of ohms.

The green vertical line indicates a frequency of 1.91417 MHz, which corresponds to the resonance frequency of the crystal used in the ultrasonic transducer, which guarantees the best performance of the crystal. However, the range of frequencies between this frequency and the anti-resonance are also possible working frequencies.

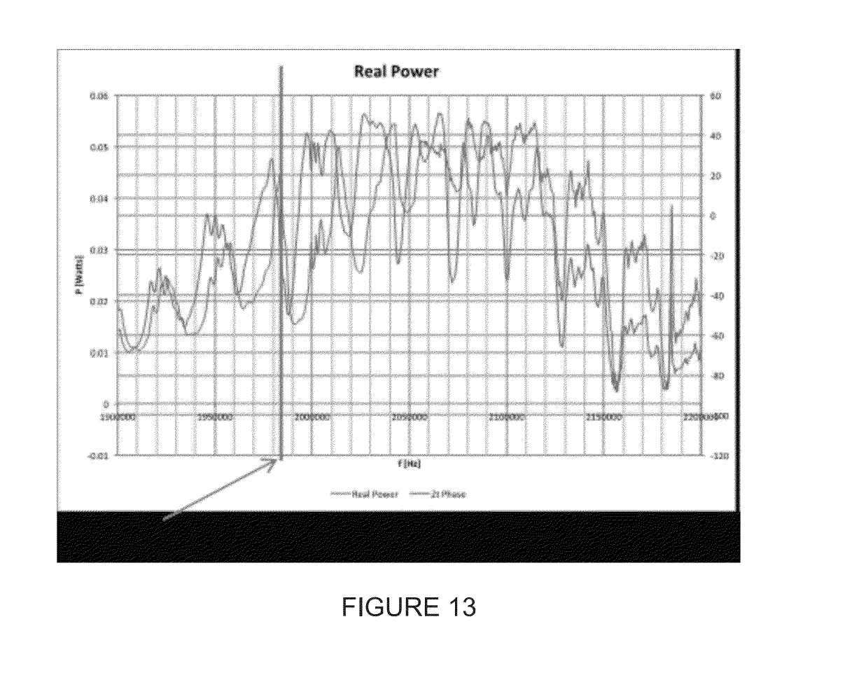

FIG. 13 contains the curves of Real Power vs. Frequency and Phase Angle vs. Frequency. The real power is the light blue line, and the phase angle is the dark red line (same as FIG. 12). The x-axis is the frequency, in Hz. The y-axis on the right-hand side is for the phase angle, which has units of degrees. The y-axis on the left-hand side is for the real power, which has units of watts. The green vertical line indicates a frequency of 1.91417 MHz, which corresponds to the resonance frequency of the crystal used in the ultrasonic transducer and is one of the local Real Power maximums.

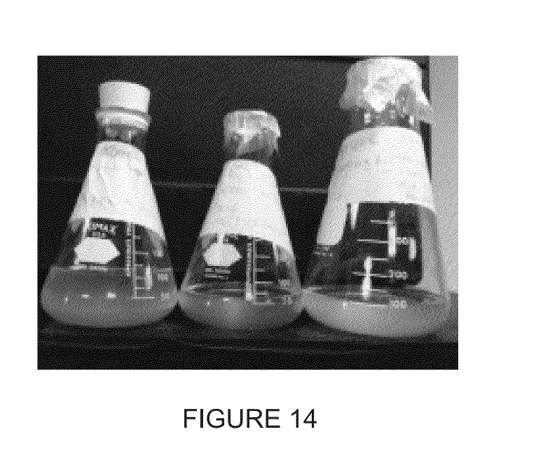

FIG. 14 is a picture of three different flasks. The left flask contains the original solution of acetaminophen/excipients in ethanol, before acoustophoretic separation. The center flask contains the solution captured at the outlet of the flow chamber after acoustophoretic solution. The right flask contains the residual solution collected from the flow chamber. As seen here, the center flask is lighter than the left flask, indicating the acoustophoretically separated solution contained fewer suspended particles than the original solution. The right flask is darker than the left flask and the center flask, indicating that the residual solution in the flow chamber contained more suspended particles than the original solution. This indicates that the acoustophoretic process successfully separated the particles.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A process for isolating an active ingredient from a pharmaceutical delivery system, comprising:
dissolving the pharmaceutical delivery system in a solvent to form a fluid stream that contains the active ingredient dissolved in the solvent and suspended particles derived from the pharmaceutical delivery system;
flowing the fluid stream through an apparatus that comprises:
a flow chamber having at least one inlet and at least one outlet;
at least one ultrasonic transducer located on a wall of the flow chamber, the transducer including a piezoelectric material; and
a reflector located on the wall on the opposite side of the flow chamber from the at least one ultrasonic transducer; and
generating a multi-dimensional standing wave in the flow chamber to capture the suspended particles in the fluid stream; and
recovering the solvent and the active ingredient dissolved in the solvent.

2. The process of claim 1, wherein the suspended particles are excipients from the pharmaceutical delivery system.

3. The process of claim 1, wherein the frequency of the at least one ultrasonic transducer is equal to or greater than 1 MHz.

4. The process of claim 1, wherein the fluid stream flows sequentially past a first ultrasonic transducer, a second ultrasonic transducer, and a third ultrasonic transducer; wherein the second ultrasonic transducer operates at a higher frequency than the first ultrasonic transducer, and the third ultrasonic transducer operates at a higher frequency than the second ultrasonic transducer.

5. The process of claim 4, wherein the second ultrasonic transducer operates at a frequency at least 1 MHz greater than the frequency of the first ultrasonic transducer, and the third ultrasonic transducer operates at a frequency at least 1 MHz greater than the frequency of the second ultrasonic transducer.

6. The process of claim 1, further comprising applying an electric field to the fluid stream to further capture suspended particles in the fluid stream.

7. The process of claim 1, wherein the apparatus comprises a communition chamber upstream of the flow chamber in which the pharmaceutical delivery system is broken up and dissolved in the solvent to form the fluid stream.

8. The process of claim 1, wherein the multi-dimensional standing wave is normal to the flow direction of the fluid stream.

9. The process of claim 1, wherein the ultrasonic transducer comprises:
a housing having a top end, a bottom end, and an interior volume; and
a crystal at the bottom end of the housing having an exposed exterior surface and an interior surface, the crystal being able to vibrate when driven by a voltage signal.

10. The process of claim 9, wherein a backing layer contacts the interior surface of the crystal, the backing layer being made of a substantially acoustically transparent material.

11. The process of claim 10, wherein the substantially acoustically transparent material is balsa wood, cork, or foam.

12. The process of claim 10, wherein the substantially acoustically transparent material has a thickness of up to 1 inch.

13. The process of claim 10, wherein the substantially acoustically transparent material is in the form of a lattice.

14. The process of claim 9, wherein an exterior surface of the crystal is covered by a wear surface material with a thickness of a half wavelength or less, the wear surface material being a urethane, epoxy, or silicone coating.

15. The process of claim 9, wherein the crystal has no backing layer or wear layer.

16. The process of claim 1, wherein the fluid stream flows from an apparatus inlet through an annular plenum and past a contoured nozzle wall prior to entering the flow chamber inlet.

17. The process of claim 1, wherein the fluid stream flows from an apparatus inlet through an annular plenum and past a contoured nozzle wall to generate large scale vortices at the entrance to a collection duct prior to entering the flow chamber inlet, thus enhancing separation of the suspended particles from the active ingredient.

18. The process of claim 1, wherein the reflector has a non-planar surface.

19. The process of claim 1, wherein the apparatus further comprises:
an apparatus inlet that leads to an annular plenum;
a contoured nozzle wall downstream of the apparatus inlet;
a collection duct surrounded by the annular plenum; and
a connecting duct joining the contoured nozzle wall to the flow chamber inlet.
